(19) United States
(12) Patent Application Publication
(10) Pub. No.: US 2014/0104227 A1
(43) Pub. Date: Apr. 17, 2014

(54) TOUCH PANEL AND METHOD FOR MANUFACTURING THE SAME

(71) Applicant: SAMSUNG ELECTRO-MECHANICS CO., LTD., Suwon (KR)

(72) Inventors: Tae Hoon Kim, Suwon (KR); Seung Min Lee, Suwon (KR); Youn Soo Kim, Suwon (KR); Ho Joon Park, Suwon (KR); Jae Chan Park, Suwon (KR)

(73) Assignee: SAMSUNG ELECTRO-MECHANICS CO., LTD., Suwon (KR)

(21) Appl. No.: 13/757,560

(22) Filed: Feb. 1, 2013

(30) Foreign Application Priority Data
Oct. 17, 2012 (KR) 10-2012-0115419

(51) Int. Cl. G06F 3/044

(52) U.S. Cl. CPC G06F 3/044
USPC 345/174; 427/108; 205/122; 430/319

(57) ABSTRACT

Disclosed herein are a touch panel and a method for manufacturing the same, the touch panel including: a transparent substrate; a photosensitive ink layer patterned on the transparent substrate and having electric conductivity; and electrode patterns formed at corresponding positions on the patterned photosensitive ink layer, and the method including: preparing a transparent substrate; coating a photosensitive ink having electric conductivity on the transparent substrate to form a photosensitive ink layer; patterning the photosensitive ink layer; and forming electrode patterns on the patterned photosensitive ink layer.

### CROSS REFERENCE TO RELATED APPLICATION

This application claims the benefit of Korean Patent Application No. 10˜2012-0115419, filed on Oct. 17, 2012, entitled “Touch Panel and Method for Manufacturing the Same”, which is hereby incorporated by reference in its entirety into this application.

### BACKGROUND OF THE INVENTION

1. Technical Field

The present invention relates to a touch panel and a method for manufacturing the same.

2. Description of the Related Art

A touch screen becomes a more general means for a user to intuitively interact with an electronic system, typically, an electronic system including a display for showing information therethrough. A transparent touch screen may be disposed on a variable display and/or a static image to allow information and images displayed to be seen therethrough. Touch screen technologies suitable to be used in this construction includes a resistive type, a capacitive type, a projected capacitive type, an inductive type, a surface acoustic wave type, a force type, and the like.

Many projected capacitive type and inductive type touch screens employ a conductive pattern as a sensing component. The term “projected capacitive” is referred to capability of a conductive pattern to project electric field through a relatively thick dielectric substance such as a glass panel, a finger in a glove, or the like. The inductive type touch screen includes a touch screen that induces electric field emitted and couplable with a conductive pattern, for example, induces electric field that excites a resonance circuit in a stylus.

Meanwhile, the capacitive type touch panel employs an indium tin oxide (ITO)-based conductive film. However, when this ITO is applied to a large-area touch panel, the recognition rate is low due to self RC delay expressed by a multiplication of resistance (R) and capacitance (C), and thus the ITO has difficulty in application to a large area. Moreover, in the case where a touch screen is manufactured by using an ITO-deposited film, cracks in the ITO film due to bending thereof may cause difficulty in handling.

In order to overcome problems in large screens due to RC delay, among the foregoing problems, there have been attempts to introduce additive compensation chips, but this may cause an increase in cost. In order to overcome these problems, many manufacturers are developing technology for substituting an ITO conductive film by using a metal pattern.

However, this technology causes problems that, in the case in which a general single metal is used, metal patterns are easily recognized by the user in view of visibility, due to high reflectance of metal itself, and further, glare may occur due to high reflectance and haze value against external light.

### SUMMARY OF THE INVENTION

The present invention has been made in an effort to provide a touch panel capable of improving visibility by patterning a photosensitive ink having conductivity and conducting electroplating using the photosensitive ink as a seed layer to thereby form electrode patterns.

According to a preferred embodiment of the present invention, there is provided a touch panel, including: a transparent substrate; a photosensitive ink layer patterned on the transparent substrate and having electric conductivity; and electrode patterns formed at corresponding positions on the patterned photosensitive ink layer.

The electrode patterns may have the same pattern as the patterned photosensitive ink layer through electroplating.

The photosensitive ink layer may contain conductive carbon.

The conductive carbon may include any one or a combination of Vulcan-XC-72, Ketjen black, acetylene black, active carbon, and carbon nanotube.

The photosensitive ink layer may contain 1˜15 wt. % of conductive carbon, 3˜10 wt. % of a photo-initiator, 15˜20 wt. % of a photosensitive resin, 5˜30 wt. % of a multi-functional monomer, 0.1˜2 wt. % of an additive, and a solvent as the remainder.

The touch panel may further include a coating layer covering a region including the electrode patterns on the transparent substrate.

The touch panel may further include, while the photosensitive ink layer and the electrode patterns are formed on one surface of the transparent substrate, a transmittance compensating layer formed on the other surface of the transparent substrate.

According to another preferred embodiment of the present invention, there is provided a method for manufacturing a touch panel, the method including: preparing a transparent substrate; coating a photosensitive ink having electric conductivity on the transparent substrate to form a photosensitive ink layer; patterning the photosensitive ink layer; and forming electrode patterns on the patterned photosensitive ink layer.

Here, in the forming of the electrode patterns on the patterned photosensitive ink layer, electroplating may be performed by using the photosensitive ink layer as a seed layer.

The patterning of the photosensitive ink layer may include forming a patterned resist above the coated photosensitive ink layer; performing exposing using the resist; and removing the resist and then developing the photosensitive ink layer.

The photosensitive ink layer may contain conductive carbon.

The conductive carbon may include any one or a combination of Vulcan-XC-72, Ketjen black, acetylene black, active carbon, and carbon nanotube.

The photosensitive ink layer may contain 1˜15 wt. % of conductive carbon, 3˜10 wt. % of a photo-initiator, 15˜20 wt. % of a photosensitive resin, 5˜30 wt. % of a multi-functional monomer, 0.1˜2 wt. % of an additive, and a solvent as the remainder.

Here, in the forming of the electrode patterns, the electrode patterns may be formed to have a line width of 3 μm or less.

The electrode patterns may have a thickness in the range of 50 nm-5 μm.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a state view showing a structure of a touch panel according to a preferred embodiment of the present invention;

FIG. 2 is a cross-sectional view of a touch panel according to another preferred embodiment of the present invention;

FIG. 3 is a cross-sectional view of a touch panel according to still another preferred embodiment of the present invention;

FIGS. 4A to 4E are process views showing a method for manufacturing the touch panel according to the present invention; and

FIG. 5 is a flow chart showing the method for manufacturing the touch panel according to the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

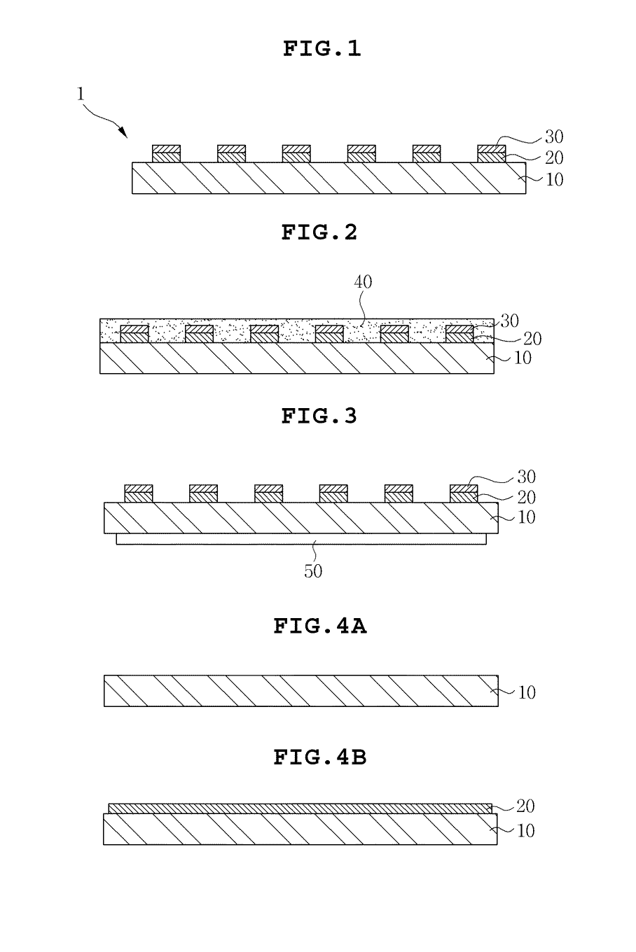

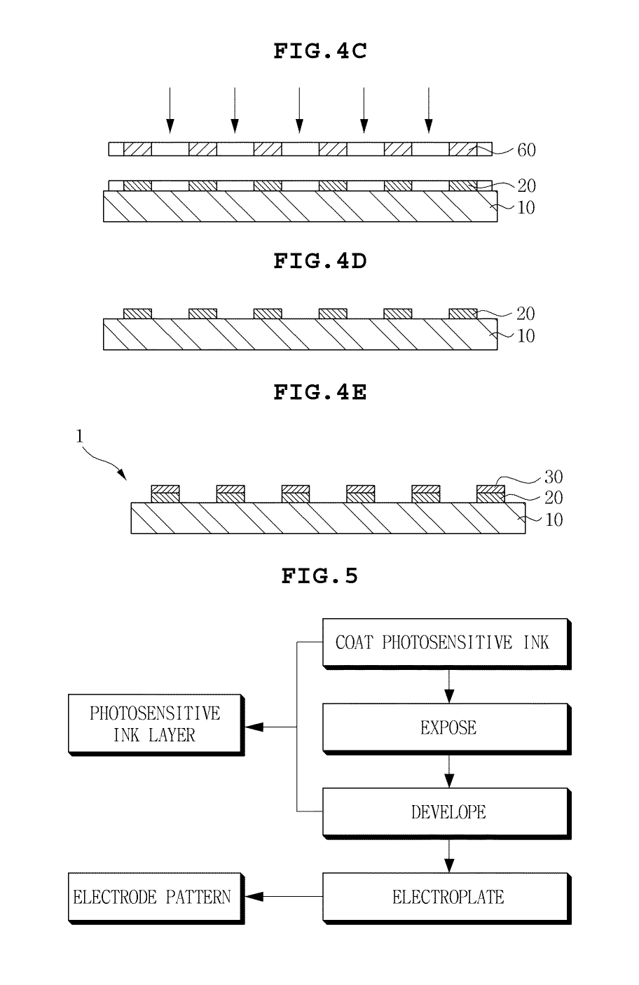

FIG. 1 is a state view showing a structure of a touch panel according to a preferred embodiment of the present invention; FIG. 2 is a cross-sectional view of a touch panel according to another preferred embodiment of the present invention; FIG. 3 is a cross-sectional view of a touch panel according to still another preferred embodiment of the present invention; FIGS. 4A to 4E are a process view showing a method for manufacturing the touch panel according to the present invention; and FIG. 5 is a flow chart showing the method for manufacturing the touch panel according to the present invention.

A touch panel according to a preferred embodiment of the present invention may include: a transparent substrate 10; a photosensitive ink layer 20 patterned on the transparent substrate 10 and having electric conductivity; and electrode patterns 30 formed at corresponding positions on the patterned photosensitive ink layer 20.

A material for the transparent substrate 10 is not particularly limited, as long as it can have a predetermined level of hardness or higher, but may be preferably formed of polyethylene terephthalate (PET), polycarbonate (PC), polymethylmethacrylate (PMMA), polyethylene naphthalate (PEN), polyether sulfone (PES), cyclic olefin polymer (COC), a triacetylcellulose (TAC) film, a polyvinyl alcohol (PVA) film, a polyimide (PI) film, polystyrene (PS), biaxially oriented polystyrene (BOPS; containing K resin), glass, tempered glass, or the like. In addition, since a transparent electrode is formed on one surface of the transparent substrate 10, a surface treatment layer may be formed on one surface of the transparent substrate 10 by performing a high frequency treatment, a primer treatment, or the like on one surface of the transparent substrate 10, to improve adhesion between the transparent substrate 10 and the transparent electrode.

The photosensitive ink layer 20 is formed on the transparent substrate 10. Particularly, as shown in FIG. 1, the photosensitive ink layer 20 may be patterned on the transparent substrate 10, and thus is formed in the same pattern as the below-described electrode patterns 30. The photosensitive ink layer 20 is patterned through exposing and developing processes, to thereby allow formation of a fine pattern, so that fine electrode patterns 30 having the same pattern as the photosensitive ink layer 20 can be realized (a manufacturing method thereof will be described later). Since the photosensitive ink layer 20 is capable of serving as an electrode of the touch panel together with the below-described electrode patterns 30, the photosensitive ink layer 20 needs to contain an appropriate conductive material to exhibit electric conductivity. Specifically, the electric conductivity may be exhibited by containing a conductive carbon in a photosensitive ink constituting the photosensitive ink layer 20. Here, the conductive carbon may contain any one or a combination of Vulcan-XC-72, Ketjen black, acetylene black, active carbon, and carbon nanotube.

In addition, the photosensitive ink may be used by being conventionally prepared, or may be used by adding 1˜15 wt. % of conductive carbon to a photosensitive ink composition commercially available. Here, if the use amount of conductive carbon is below 1 wt. %, conductivity is dropped, which may cause electroplating for the electrode patterns 30 to be difficult. If above 15 wt. %, reliability may be deteriorated during the exposing and developing processes of the photosensitive ink layer 20.

The photosensitive ink composition according to one preferred embodiment of the present invention may include, for example, 1˜15 wt. % of conductive carbon, 3˜10 wt. % of a photo-initiator, 15˜20 wt. % of a photosensitive resin, 5˜30 wt. % of a multi-functional monomer, and 0.1˜2 wt. % of an additive such as a coupler, and the remainder may be a solvent. As the solvent, for example, propylene glycol methyl ether acetate (PEGMEA) or the like may be used. The photosensitive ink layer 20 formed of this ink can secure reliability during exposing and developing processes for patterns and operating reliability in view of electric conductivity together with the electrode patterns 30.

As shown in FIG. 1, the electrode patterns 30 may be formed on the patterned photosensitive ink layer 20 in the same pattern as the patterned photosensitive ink layer. Particularly, in order to realize the electrode patterns 30 to have a pattern exactly matching with the pattern of the photosensitive ink layer 20, electroplating may be performed by using the patterned photosensitive ink layer 20 as a medium (seed layer). The electrode patterns 30 are formed on the patterned photosensitive ink layer 20 by electroplating, so that the electrode patterns having the same pattern as the photosensitive ink layer 20 may be realized, and a fine pattern by the photosensitive ink layer 20, as it is, can be realized as the electrode pattern 30. In addition, a separate black oxide treatment or the like to solve visible problems of the touch panel due to the electrode patterns 30 is unnecessary, and thus, the process can be simpler and the precision in realization of the electrode patterns 30 can be improved. The electroplating is performed on the photosensitive ink layer 20 by a general process, and descriptions thereof will be omitted.

The present invention discloses the structure where the electrode patterns 30 are formed on one surface of the transparent substrate 10 and the process therefor, but those skilled in the art may easily change the design thereof, into a self cap type touch panel where the electrode patterns 30 are formed on only one surface of the transparent substrate 10 or a mutual type touch panel where the electrode patterns 30 are formed on one surface of the transparent substrate 10, which is then combined with another transparent substrate having alternating electrode patterns at corresponding positions. Detailed descriptions thereof will be omitted.

In addition, as shown in FIG. 2, the touch panel according to another preferred embodiment of the present invention may further include a coating layer 40 covering a region including the electrode pattern 30. That is, in the case where one surface of the transparent substrate 10 on which the electrode patterns 30 are formed is touched, a separate coating layer 40 may be formed to protect the electrode patterns 30 and prevent infiltration of foreign materials. Here, the coating layer 40 may be formed of glass, or by a hard-coating treatment.

In addition, as shown in FIG. 3, a transmittance compensating layer 50 is further formed on the other surface of the transparent substrate 10, which is opposite to one surface of the transparent substrate 10 on which the electrode patterns 30 are formed, thereby appropriately compensating for deterioration in visibility of the touch panel due to the image output by a display part coupled with the touch panel.

FIGS. 4A to 4E are a process view showing a method for manufacturing the touch panel according to the present invention; and FIG. 5 is a flow chart showing the process for manufacturing the touch panel according to the present invention.

A method for manufacturing a touch panel according to one preferred embodiment of the present invention may include: preparing a transparent substrate 10; coating a photosensitive ink having electric conductivity on the transparent substrate 10 to form a photosensitive ink layer 20; patterning the photosensitive ink layer 20; and forming electrode patterns 30 on the patterned photosensitive ink layer 20.

Specifically, as shown in FIGS. 4A and 4B, first, a transparent substrate 10 is prepared, and then, a photosensitive ink having electric conductivity is coated on the transparent substrate 10 to form a photosensitive ink layer 20. As the method of coating the photosensitive ink on the transparent substrate 10, various methods such as screen printing, sputtering, and the like, may be selected, and besides, printing technology of the prior art known to those skilled in the art is also applied thereto. Meanwhile, the photosensitive ink for the photosensitive ink layer 20 having conductivity may be prepared by adding a small amount of metal particles thereto. In the case where electroplating is performed in order to the below-described electrode patterns 30, several kinds of metals such as Cu, Sn, and the like may be used.

Then, as shown in FIGS. 4C and 4D, the photosensitive ink layer 20 is patterned. In order to pattern the photosensitive ink layer 20, a separate patterned resist 60 may be formed. An exposing process is performed by using the patterned resist 60, which is then removed, then a developing process is performed by etching the photosensitive ink layer 20 subjected to the exposing process with a developing solution, thereby finally forming the patterned photosensitive ink layer 20. Here, a portion of the photosensitive ink layer 20 that is not exposed through the resist 60 may be etched and removed by the developing solution or an exposed portion of the photosensitive ink layer 20 may be etched and removed by the developing solution. These may be freely selected by those skilled in the art depending on material characteristics and properties of the photosensitive ink layer 20.

Then, as shown in FIG. 4E, the electrode patterns 30 are formed on the patterned photosensitive ink layer 20. Here, the electrode patterns 30 may be formed by electroplating using the patterned photosensitive layer 20 as a seed layer. The electroplating may be performed by using copper or the like, and here, any metal material that can exhibit electric conductivity may be used without particular limitation. The electrode patterns 30 are formed on the photosensitive ink layer 20 by electroplating, so that the electrode patterns 30 can be formed to correspond to a finely patternable photosensitive ink layer 20. Realization of these fine electrode patterns 30 can result in improvement in sensing performance or driving reliability of the touch panel.

Particularly, in the forming of the electrode patterns 30, the electrode patterns 30 may be realized to be fine patterns with a line width of 3 μm or less. The electrode patterns 30 may have a thickness in the range of 50 nm˜5 μm, considering electric conductivity and operating reliability of the electrode patterns 30. If the electrode pattern 30 becomes too thin, touch sensitivity may be deteriorated. If the electrode pattern 30 becomes too thick, realization of a thinner touch panel may be difficult due to an increase in the overall thickness of the touch panel and precision in realization of the electrode pattern 30 by electroplating may be deteriorated.

In addition, the method for manufacturing the touch panel 1 will be described as follows. The photosensitive ink is coated on the transparent substrate 10 by spin coating, and then soft-baked on a hot plate at a temperature of 100° C. for 100 seconds. Exposing through is performed using an energy of 40 mJ/cm², and then developing was performed using 2 wt. % calcium hydroxide solution for 60 seconds, followed by washing with pure water for 1 minutes.

The thus obtained patterns are hard-baked in an oven at 230° C. for 30 minutes, to form a transparent conductive pattern. A mask for circuit is realized to have a pitch interval of about 250 μm and a line width of about 3 μm, and here, a sheet resistance of 700 ohm/square may be obtained.

In order to form a TSP electrode, each wiring part is subjected to electrolytic copper plating to thereby increase Cu thickness to 30 nm. Here, the sheet resistance of a transparent conductive mesh may be 20 ohm/square.

Thus, the entire surface of the touch panel 1 may have an effect of being subjected to black oxide treatment, and thus the touch panel entirely looks black, resulting in improved visibility. In the under layer, a low-resistance wiring having a pitch interval of about 250 μm and a line width of about 3 μm can be formed due to Cu plating.

As set forth above, according to the present invention, the photosensitive ink applied to the touch panel results in a reduction in visibility of the electrode patterns, thereby suppressing the electrode patterns from being visible by an eye of the user.

Further, since the electrode patterns are formed by performing electroplating on the photosensitive ink layer patterned through patterning of the photosensitive ink, fine electrode patterns can be obtained, resulting in improvement in sensitivity, and thus operating reliability of the touch panel can be improved.

Further, since visibility of the touch panel is improved, quality of the touch panel can be improved. In addition, reliability of products can be improved through accurate arrangement of the photosensitive ink layer and the electrode patterns at the time of manufacturing the touch panel.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch panel, comprising:
a transparent substrate;
a photosensitive ink layer patterned on the transparent substrate and having electric conductivity; and
electrode patterns formed at corresponding positions on the patterned photosensitive ink layer.

2. The touch panel as set forth in claim 1, wherein the electrode patterns have the same pattern as the patterned photosensitive ink layer through electroplating.

3. The touch panel as set forth in claim 1, wherein the photosensitive ink layer contains conductive carbon.

4. The touch panel as set forth in claim 3, wherein the conductive carbon includes any one or a combination of Vulcan-XC-72, Ketjen black, acetylene black, active carbon, and carbon nanotube.

5. The touch panel as set forth in claim 1, wherein the photosensitive ink layer contains 1˜15 wt. % of conductive carbon, 3˜10 wt. % of a photo-initiator, 15˜20 wt. % of a photosensitive resin, 5˜30 wt. % of a multi-functional monomer, 0.1˜2 wt. % of an additive, and a solvent as the remainder.

6. The touch panel as set forth in claim 1, further comprising a coating layer covering a region including the electrode patterns on the transparent substrate.

7. The touch panel as set forth in claim 1, further comprising, while the photosensitive ink layer and the electrode patterns are formed on one surface of the transparent substrate, a transmittance compensating layer formed on the other surface of the transparent substrate.

8. A method for manufacturing a touch panel, the method comprising:
preparing a transparent substrate;
coating a photosensitive ink having electric conductivity on the transparent substrate to form a photosensitive ink layer;
patterning the photosensitive ink layer; and
forming electrode patterns on the patterned photosensitive ink layer.

9. The method as set forth in claim 8, wherein, in the forming of the electrode patterns on the patterned photosensitive ink layer, electroplating is performed by using the photosensitive ink layer as a seed layer.

10. The method as set forth in claim 8, wherein the patterning of the photosensitive ink layer includes:
forming a patterned resist above the coated photosensitive ink layer;
performing exposing using the resist; and
removing the resist and then developing the photosensitive ink layer.

11. The method as set forth in claim 8, wherein the photosensitive ink layer contains conductive carbon.

12. The method as set forth in claim 8, wherein the conductive carbon includes any one or a combination of Vulcan-XC-72, Ketjen black, acetylene black, active carbon, and carbon nanotube.

13. The method as set forth in claim 8, wherein the photosensitive ink layer contains 1˜15 wt. % of conductive carbon, 3˜10 wt. % of a photo-initiator, 15˜20 wt. % of a photosensitive resin, 5˜30 wt. % of a multi-functional monomer, 0.1˜2 wt. % of an additive, and a solvent as the remainder.

14. The method as set forth in claim 8, wherein in the forming of the electrode patterns, the electrode patterns are formed to have a line width of 3 μm or less.

15. The method as set forth in claim 8, wherein the electrode patterns have a thickness in the range of 50 nm-5 μm.
